(19) United States
(12) Patent Application Publication
(10) Pub. No.: US 2006/0117123 A1
(43) Pub. Date: Jun. 1, 2006

(54) Information processing apparatus

(76) Inventor: Takayuki Izumida, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/273,833

(22) Filed: Nov. 15, 2005

(30) Foreign Application Priority Data
Nov. 29, 2004 (JP) 2004-344121

(51) Int. Cl. G06F 13/14

(52) U.S. Cl. 710/244

(57) ABSTRACT

A port arbitration unit of a system controller arbitrates a data transfer of each PCI Express device connected to several ports in accordance with the content of a register. A BIOS-ROM is stored with a port arbitration table group for setting the register to preferentially select the connected device for each PCI Express device. A system BIOS is stored in the BIOS-ROM, and executed by a CPU. The system BIOS selects any port arbitration table from several port arbitration tables based on user's choice, and sets the register to preferentially select the PCI Express device selected by user.

### CROSS-REFERENCE TO RELATED APPLICATIONS

This application is based upon and claims the benefit of priority from prior Japanese Patent Application No. 2004-344121, filed Nov. 29, 2004, the entire contents of which are incorporated herein by reference.

### BACKGROUND

1. Field

The present invention relates to a port arbitration control technique suitable for PCI Express applied to a personal computer.

2. Description of the Related Art

In recent years, various types of personal computer such as notebook and desktop types have come into wide spread use. In order to achieve high speed, an ISA bus, PCI bus and PCI Express bus are used as a system bus provided for transferring data in these kinds of personal computer.

The system bus is shared between several devices. For this reason, various arbitration methods of effectively using the system have been proposed (for example, see JPN. PAT. APPLN. KOKAI Publications No. 2002-312309, 10-228446 and 11-110344).

In the foregoing PCI Express, the arbitration is made using information held in a table called a port arbitration table. Specifically, the following setup is carried out based on the information. According to the setup, data transfer (traffic) of a device connected to a specific port is preferentially made in some devices connected to a PCI Express port.

Usually, only one port arbitration table is fixedly stored in a Basic Input/Output System (BIOS) ROM. According to the IRT routine of a system BIOS carried out when the system starts, the priority sequence is set between several ports. Thus, one kind of priority sequence is only set so far every system.

However, in the same type personal computer, a certain user prefers data transfer of a device A to that of a device B. On the other hand, a certain user prefers data transfer of the device B to that of the device A. As described above, user deeply hopes to change the priority setup in accordance with the purpose for use.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is an exemplary block diagram showing the configuration of an information processing apparatus (computer system) according to one embodiment of the present invention;

FIG. 2 is an exemplary functional block diagram to explain the operation of a port arbitration unit included in the computer system of the embodiment;

FIG. 3 is an exemplary view showing a system setup screen provided by a system BIOS included in the computer system of the embodiment;

FIGS. 4A, 4B and 4C are exemplary views showing the content of a port arbitration table used for the computer system of the embodiment;

FIG. 5 is an exemplary flowchart to explain the port priority setup procedure in the computer system of the embodiment;

FIGS. 6A, 6B, 6C and 6D are exemplary views showing the content of a port arbitration table (applied example) used for the computer system of the embodiment;

FIG. 7A and FIG. 7B are exemplary views showing the content of a VC arbitration table used for the computer system of the embodiment; and

FIG. 8 is an exemplary flowchart to explain the port priority setup procedure (applied example) in the computer system of the embodiment.

### DETAILED DESCRIPTION

Various embodiments according to the invention will be described below with reference to the accompanying drawings.

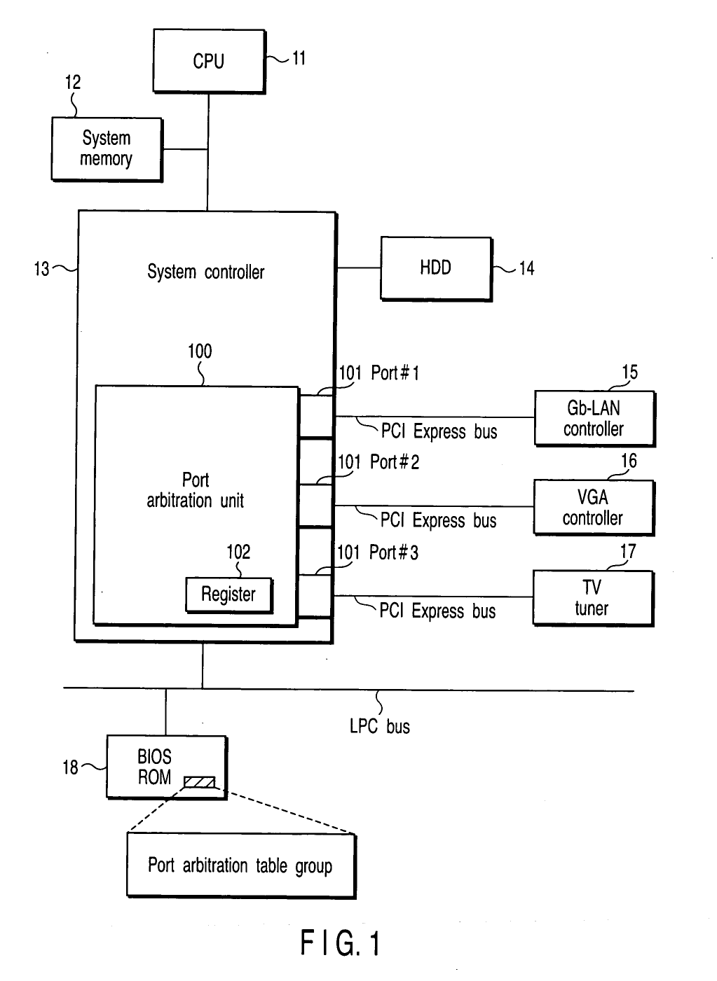

FIG. 1 is a block diagram showing the configuration of an information processing apparatus (computer system) according to one embodiment of the present invention. The computer system is realized as notebook and desktop type personal computer, for example. As shown in FIG. 1, the computer system includes CPU 11, system memory 12, system controller 13, (magnetic) hard disk drive (HDD) 14, Gb-LAN controller 15, VGA controller 16, TV tuner 17 and BIOS-ROM 18.

The CPU 11 is a processor controlling the operation of the computer system. The CPU 11 executes operating system and various application programs loaded from the HDD 14 into the system memory 12. Moreover, the CPU 11 executes system BIOS stored in the BIOS-ROM 18. The system BIOS is a hardware control program.

The system memory 12 is a high-speed accessible storage medium used as a main memory of the computer system. The system memory 12 temporarily stores the foregoing operating system and various application programs executed by the CPU 11. The system controller 13 is a bridge device making a connection between a local bus of the CPU 11 and a system bus, that is PCI Express bus and LPC bus. The PCI Express bus is a serial bus; for this reason, the system controller 13 is provided with a port arbitration unit 100 making arbitration to avoid a conflict of data transfer. The port arbitration unit 100 can set the priority sequence of several PCI Express ports 101 for included in the system controller 13 based on values of a register 102. The computer system arbitrarily makes the foregoing priority setup in accordance with the purpose of use, and this will be described later.

The HDD 14 is a storage medium used as an external storage of the computer system. The HDD 14 stores a large amount of assorted programs and data as auxiliary storage. The foregoing Gb-LAN controller 15, VGA controller 16 and TV tuner 17 are all PCI Express devices connected to PCI Express ports 101 for included in the system controller. Therefore, the port arbitration unit 100 arbitrates data transfer between the system controller 13 and these controllers. The Gb-LAN controller 15 controls communications via LAN. The VGA controller 16 controls screen display by LCD. The TV tuner 17 receives a specific channel broadcast signal from TV broadcast signals input via an antenna.

The BIOS-ROM 18 is a program rewritable storage medium storing system BIOS executed by the CPU 11. The BIOS-ROM 18 is stored with several port arbitration tables for arbitrarily setting priority control of ports 101 by the port arbitration unit 100. The port arbitration tables will be described later.

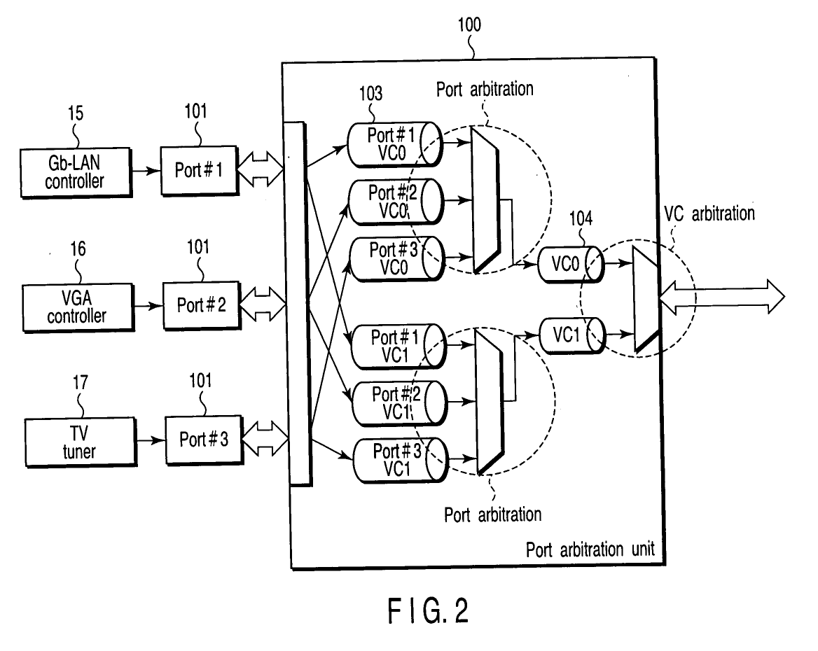

FIG. 2 is a functional block diagram to explain the operation of the port arbitration unit 100. In order to clarify the explanation, three PCI Express ports 101 (#1 to #3) are given in FIG. 2; however, the number of ports is not limited to three.

Data transferred to port 101 from each device is shared to some buffers 103 provided independently for each port. The buffer 103 forms a couple with the buffer 103 of another port 101, and one shared buffer 104 is provided for each couple. Data transfer from any buffer 103 to the shared buffer 104 is exclusively made for each couple. In this case, selecting any buffer 103 is arbitration by the port arbitration unit 100, and the register 102 determines the priority. In FIG. 2, two shared buffers, that is, VC0 and VC1 are only shown; however, the number of shared buffers is not limited to two.

The register 102 of the port arbitration unit 100 is set according to an IRT routine of the system BIOS executed when the system starts. The system BIOS of the computer system provides a screen for preferentially selecting which of several PCI Express devices. Based on the screen operation, the register 102 is set so that a port 101 connected with the selected PCI Express device, that is, data transfer from the buffer 103 of the port 101 to the shared buffer 104 is preferentially made. For this reason, the BIOS-ROM 18 is stored with a port arbitration table for setting the register 102 to preferentially select the device for each PCI Express device.

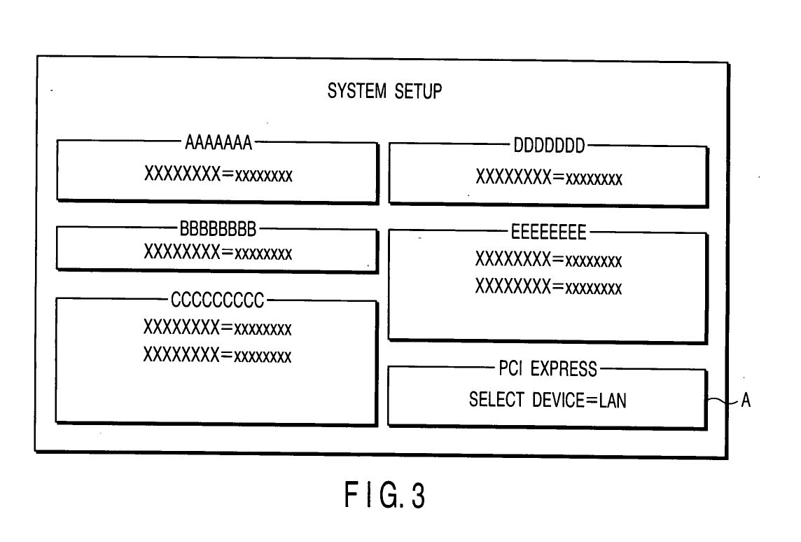

FIG. 3 is a view showing a system setup screen provided by the system BIOS. In a column A shown at the lower right on the screen, that is, “PCI EXPRESS”, the user selects a PCI Express device to be preferentially selected. By doing so, the port 101 connected with the PCI Express device is preferentially selected even if user do not know which port the device is connected. In FIG. 3, there is shown an example in which the GB-LAN controller 16 is preferentially selected. In this case, the select target is toggled using a cursor key; therefore, the user displays a PCI Express device to be preferentially selected, and thereafter, sets it.

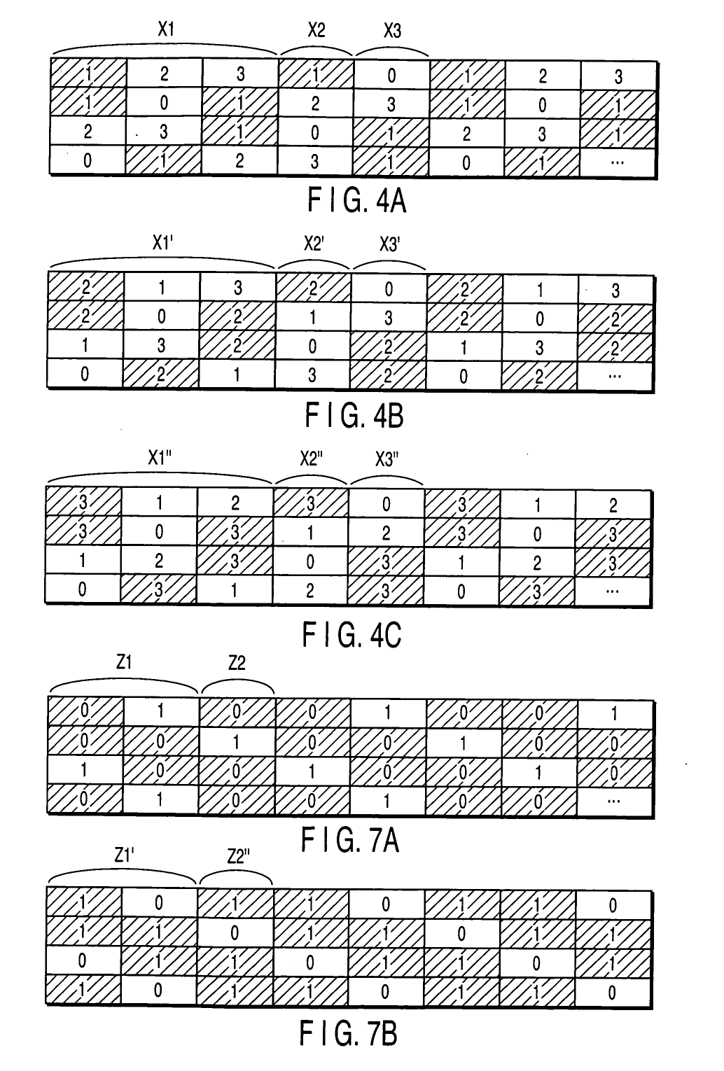

Referring now to FIGS. 4A, 4B and 4C, the port arbitration table will be explained below. FIG. 4A shows a table for more preferentially selecting a port 101 connected with the Gb-LAN controller 15 than other ports 101. FIG. 4B shows a table for more preferentially selecting a port 101 connected with the VGA controller 16 than other ports 101. FIG. 4C shows a table for more preferentially selecting a port 101 connected with the TV tuner 17 than other ports 101. Of the foregoing three tables, the table of FIG. 4A for more preferentially selecting a port 101 connected with the Gb-LAN controller 15 than other ports 101 will be detailedly explained below.

The table is given so that values held like a two-dimensional matrix are repeatedly referred from the upper left toward the lower right. In the table, “1” to “3” each show a port number to be preferentially selected, and “0” shows that any port is selected at random without carrying out priority control. “1” is number of the port 101 connected with the Gb-LAN controller 15. “2” is number of the port 101 connected with the VGA controller 16. “3” is number of the port 101 connected with the TV tuner 17.

According to the table shown in FIG. 4A, the following patterns are given. According to the given first pattern (X1), each port connected with Gb-LAN controller 15, VGA controller 16 and TV tuner 17 is equally preferentially designated by one-time. According to the given second pattern (X2), the port connected with the Gb-LAN controller 15 is preferentially designated. According to the given third pattern (X3), any port is designated at random. Thereafter, the first to third patterns are repeated.

In other words, the table value is set in the register 102, and thereby, the port arbitration unit 100 makes the following port arbitration. Specifically, the opportunity of more preferentially selecting only port connected with the Gb-LAN controller 15 than other ports increases. When the Gb-LAN controller 15 is selected on the system setup screen shown in FIG. 3, the system BIOS sets the port arbitration unit 100, that is, register 102 using the table shown in FIG. 4A.

Likewise, in the table of FIG. 4B, the second pattern (X2′) value is held so that the opportunity of more preferentially selecting only port connected with the VGA controller 16 than other ports increases. In the table of FIG. 4C, the second pattern (X2″) value is held so that the opportunity of more preferentially selecting only port connected with the TV tuner 17 than other ports increases.

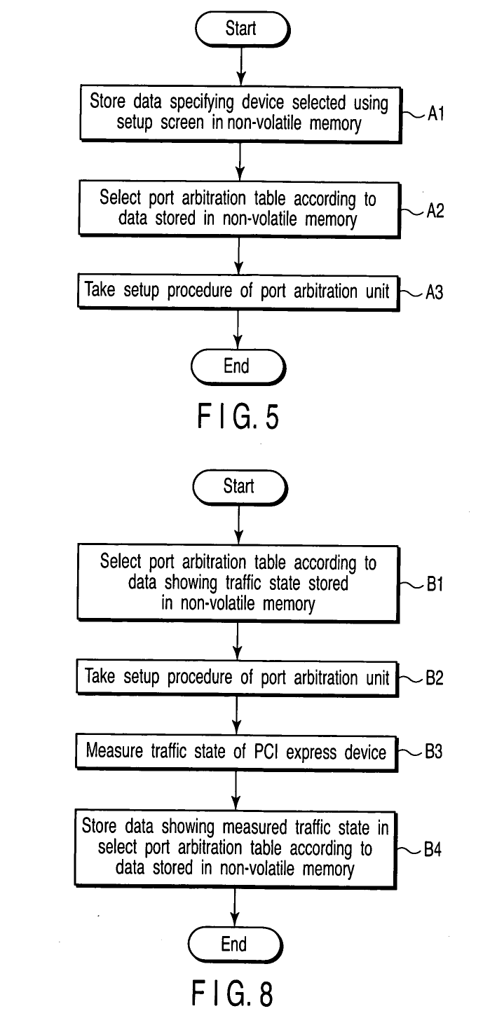

The port priority setup procedure of the computer system will be explained below with reference to FIG. 5.

When the user selects any PCI Express device on the system setup screen, the system BIOS stores data showing the selected PCI Express device in non-volatile memory, that is, the BIOS-ROM 18 (step A1). Then, when the system is started, the system BIOS selects a port arbitration table for preferentially selecting the selected PCI Express device according to the foregoing data stored in the BIOS-ROM 18 (step A2). Thereafter, the system BIOS takes a setup procedure of the port arbitration unit 100 using the port arbitration table (step A3).

By doing so, it is possible to arbitrarily set port arbitration control for PCI Express in accordance with the purpose of use.

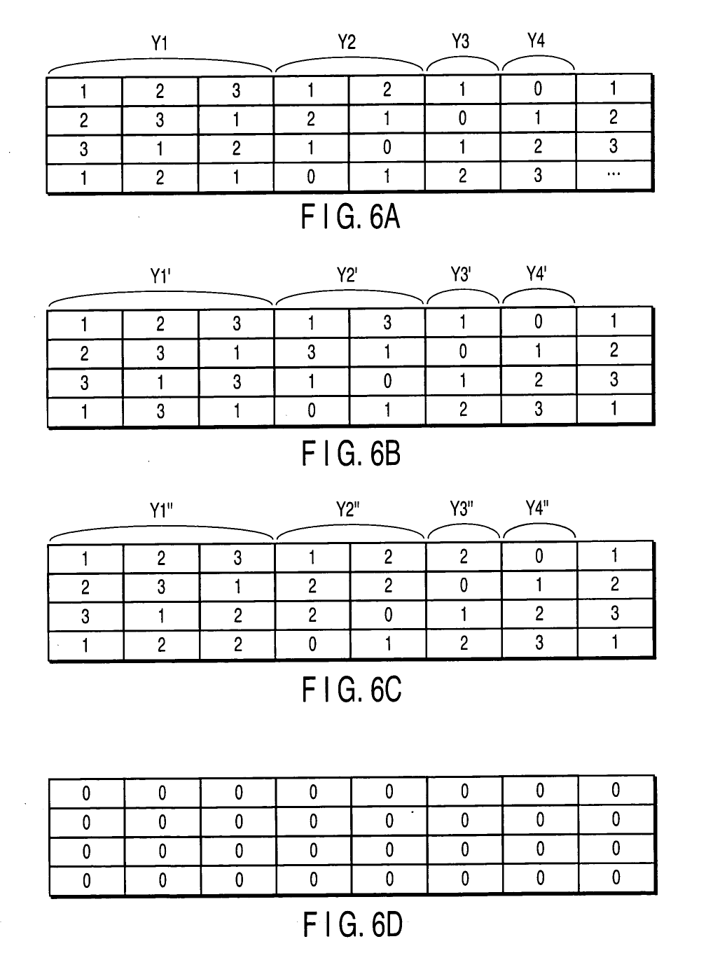

FIG. 3 shows the example of more preferentially selecting any of several PCI Express devices, that is, Gb-LAN controller 15, VGA controller 16 and TV tuner 17 than other PCI Express devices. Moreover, the foregoing port arbitration table may be modified to preferentially select those devices according to the given sequence. FIGS. 6A, 6B, 6C and 6D shows the configuration of a port arbitration table used for realizing the preceding matter.

Now, the user makes a setup of preferentially selecting a port (device) according to the sequence of Gb-LAN controller 15>VGA controller 16>TV tuner 17. A table shown in FIG. 6A is used for realizing the foregoing priority control.

According to the table shown in FIG. 6A, the following patterns are given. According to the given first pattern (Y1), each port connected with Gb-LAN controller 15, VGA controller 16 and TV tuner 17 is equally preferentially designated by one-time. According to the given second pattern (Y2), each port connected with Gb-LAN controller 15 and VGA controller 16 is preferentially designated by one-time. According to the given third pattern (Y3), only port connected with Gb-LAN controller 15 is preferentially designated. According to the given fourth pattern (Y4), any port is designated at random. Thereafter, the first to fourth patterns are repeated.

In other words, the table value is set in the register 102, and thereby, the port arbitration unit 100 makes the following port arbitration. Specifically, the opportunity of preferentially selecting a port increases in the sequence of port connected with the Gb-LAN controller 15>port connected with the VGA controller 16>port connected with the TV tuner 17.

In order to obtain the sequence of Gb-LAN controller 15>TV tuner 17>VGA controller 16, the VGA controller 16 is replaced with the TV tuner 17 in the sequence. In this case, as seen from the table of FIG. 6B, a second pattern (Y2′) is given; namely, the TV tuner 17 is preferentially selected in place of the VGA controller 16.

Likewise, in order to obtain the sequence of VGA controller 16>Gb-LAN controller 15>TV tuner 17, the Gb-LAN controller 15 is replaced with the VGA controller 16 in the sequence. In this case, as seen from the table of FIG. 6C, a third pattern (Y3″) is given; namely, the VGA controller 16 is preferentially selected in place of the Gb-LAN controller 15.

Moreover, in order to equally select the foregoing Gb-LAN controller 15, VGA controller 16 and TV tuner 17, no priority control is carried out, and therefore, the table of FIG. 6D is used.

As depicted in FIG. 2, the port arbitration unit 100 makes port arbitration, and thereby, data transfer from any buffer 103 to the shared buffer 104 is exclusively made for each couple. Moreover, the port arbitration unit 100 arbitrates whether data transfer of any one of several shared buffers 104 should be preferentially made. This is called VC arbitration. The VC arbitration is controlled according to setting values of the register 102, like the foregoing port arbitration. Therefore, various tables are prepared, and thereby, the system BIOS can arbitrarily set the values.

FIG. 7A and FIG. 7B are views showing the configuration of a VC arbitration control table. FIG. 7A is a table for preferentially selecting VC0, and FIG. 7B is a table for preferentially selecting VC1. In FIG. 7A and FIG. 7B, “0” shows a value for preferentially selecting VC0, and “1” shows a value for preferentially selecting VC1.

In the table of FIG. 7A, the following patterns are given. According to the given first pattern (Z1), each shared buffer 104 of VC0 and VC1 is equally preferentially designated by one time. According to the given second pattern (Z2), only shared buffer 104 of VC0 is preferentially designated. Thereafter, the first and second patterns are repeated.

In other words, the table value is set in the register 102, and thereby, the port arbitration unit 100 makes the following port arbitration. Specifically, the opportunity of preferentially selecting the shared buffer 104 of VC0 increases as compared with the shared buffer 104 of VC1.

Conversely, in the table of FIG. 7B, a second pattern (Z2′) is given. According to the given second pattern (Z2′), only shared buffer 104 of VC0 is preferentially designated. Therefore, the opportunity of preferentially selecting the shared buffer 104 of VC1 increases as compared with the shared buffer 104 of VC0.

As described above, several tables is prepared, and any of the tables is selected by the system BIOS to make a setup of the port arbitration unit 100. This method is applicable to VC arbitration in addition to port arbitration.

Moreover, the table may be selected and set in the following manner. Specifically, the setup of port arbitration is carried out based on the user's choice. For example, the system BIOS monitors data transfer state of each port 101, and stores data showing the monitor result when the system shuts down. Then, when the system starts nest, based on the data, a port is preferentially selected in the sequence of data transfer having high frequency. FIG. 8 is a flowchart to explain the operation principle.

When the system starts, the system BIOS selects a port arbitration table for preferentially selecting a port in the sequence of data transfer having high frequency according to data showing data transfer state stored in the BIOS-ROM 18 (step B1). The system BIOS executes a setup of the port arbitration unit 100 using the selected port arbitration table (step B2).

The system BIOS monitors a data transfer (traffic) state of a PCI Express device connected to each port 101 (step B3). Then, when the system shuts down, the system BIOS stores data showing the monitor result in non-volatile memory, that is, BIOS-ROM 18 (step B4).

By doing so, based on the data transfer state of each port 101, the table is selected and set up to preferentially select a port (device) in the sequence of data transfer having high frequency.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a controller having several ports each connected with a device, and configured to set priority between the several ports;
a table management unit configured to manage several tables stored with information used for setting the priority between the several ports; and
a setting unit configured to set the priority between the several ports in the controller using the several tables managed by the table management unit.

2. The apparatus according to claim 1, wherein the table management unit manages several tables stored with information for more preferentially selecting any one of the several ports than other ports, and
the setting unit includes:
a first unit configured to preferentially select data transfer of any one of the several devices connected to the several ports; and
a second unit configured to set the priority between the several ports in the controller using one of the several tables, managed by the table management unit, stored with information for more preferentially selecting a port connected with the selected device than other ports.

3. The apparatus according to claim 1, wherein the table management unit manages several tables stored with information for preferentially selecting the several ports according to a desired sequence, and
the setting unit includes:
a first unit configured to preferentially select data transfer of devices connected to the several ports according to any of the sequence; and
a second unit configured to set the priority between the several ports in the controller using one of the several tables, managed by the table management unit, stored with information for more preferentially selecting a port connected with the selected device than other ports.

4. The apparatus according to claim 1, wherein the table management unit manages several tables stored with information for more preferentially selecting any one of the several ports than other ports, and
the setting unit includes:
a first unit configured to monitor a data transfer state of each device connected to the several ports; and
a second unit configured to set the priority between the several ports in the controller using one of the several tables, managed by the table management unit, stored with information for more preferentially selecting a port connected with a device having highest data transfer frequency by the monitoring than other ports.

5. The apparatus according to claim 1, wherein the table management unit manages several tables stored with information for more preferentially selecting the several ports in a desired sequence, and
the setting unit includes:
a first unit configured to monitor a data transfer state of each device connected to the several ports; and
a second unit configured to set the priority between the several ports in the controller using one of the several tables, managed by the table management unit, stored with information for more preferentially selecting a port connected with each device in a sequence of a device having highest data transfer frequency by the monitoring than other ports.

6. The apparatus according to claim 1, wherein the several ports included in the controller are ports which connected with Peripheral Component Interconnect (PCI) Express bus.

7. An information processing apparatus comprising:
a controller having several ports each connected with a device, several couples of buffer groups coupling several buffers making a pair with the several ports, and several shared buffers making the several couples of buffer groups, and configured to set priority between the several shared buffers;
a table management unit configured to manage several tables stored with information used for setting the priority between the several shared buffers; and
a setting unit configured to set the priority between the several shared buffers in the controller using the several tables managed by the table management unit.
